(19) United States
(12) Patent Application Publication
(10) Pub. No.: US 2020/0357216 A1
(43) Pub. Date: Nov. 12, 2020

(54) COIN DISPENSING METHOD AND CASH TRANSACTION APPARATUS

(71) Applicant: FUJITSU FRONTECH LIMITED, Tokyo (JP)

(72) Inventors: Mitsuo WATANABE, Tokyo (JP); Toshimasa MIYAKE, Tokyo (JP); Nobuhiro MATSUI, Tokyo (JP); Masanori OHKAWA, Tokyo (JP)

(73) Assignee: FUJITSU FRONTECH LIMITED, Tokyo (JP)

(21) Appl. No.: 16/938,993

(22) Filed: Jul. 26, 2020

Related U.S. Application Data
(63) Continuation of application No. PCT/JP2018/004618, filed on Feb. 9, 2018.

(51) Int. Cl. G07D 1/02; G07D 9/02; G07D 9/04; G07F 5/24

(52) U.S. Cl. CPC G07D 1/02; G07F 5/24; G07D 9/04; G07D 9/02

(57) ABSTRACT

A coin processing unit includes a control unit that causes a coin dispensing unit to dispense a prescribed number of coins in a plurality of times according to the total volume of the coins or the prescribed number of coins. Therefore, the coin processing unit is able to dispense a prescribed number of coins from the coin dispensing unit in a plurality of times according to the total volume of the coins or the prescribed number of coins. As a result, the coins dispensed from the coin dispensing unit to the coin transport unit are carried to an outlet port through the coin transport unit, without getting stuck in the coin transport unit, and are discharged to a coin receptacle.

### CROSS-REFERENCE TO RELATED APPLICATION

This application is a continuation application of International Application PCT/JP2018/004618 filed on Feb. 9, 2018 which designated the U.S., the entire contents of which are incorporated herein by reference.

### FIELD

The embodiments discussed herein relate to a coin dispensing method and a cash transaction apparatus.

### BACKGROUND

Point of sale (POS) systems are introduced in supermarkets, pharmacies, and other retail stores. A POS system includes a POS terminal and a cash transaction apparatus connected to the POS terminal. When an operator registers merchandise items to be purchased into the POS terminal, the POS terminal calculates the amount due for the merchandise items. The POS terminal also calculates the change on the basis of the amount of money received for the amount due from the customer. The cash transaction apparatus includes a bill processing unit that receives and dispenses bills and a coin processing unit that receives and dispenses coins. Such a cash transaction apparatus receives, from an operator, money a customer has paid to the operator and dispenses change to the operator (see, for example, Japanese Laid-open Patent Publication No. 2012-190240).

By the way, when the above-described coin processing unit has a shortage of coins of a certain denomination for dispensing change, the coin processing unit is able to perform alternative dispensing using smaller denominations to replace the certain denomination. However, the alternative dispensing increases the number of coins to be dispensed, and as a result, a coin jam may occur in a coin transport path or the like when the coins dispensed by the coin processing unit are carried to a coin case.

### SUMMARY

According to one aspect of the embodiments, there is provided a coin dispensing method, including: causing, by a processor, a coin dispensing unit to dispense, to a coin transport unit, a prescribed number of coins equivalent to a prescribed amount, released from a coin storage unit, in a plurality of times according to the prescribed number of coins, the coin storage unit storing therein coins by denomination; and carrying, by the coin transport unit, the prescribed number of coins dispensed by the coin dispensing unit to an outlet port of the coin transport unit and discharging the prescribed number of coins from the outlet port to outside, the coin transport unit having one end connected to the coin dispensing unit and another end, serving as the outlet port, located lower than the coin dispensing unit.

The object and advantages of the present disclosure will be realized and attained by means of the elements and combinations particularly pointed out in the claims.

It is to be understood that both the foregoing general description and the following detailed description are exemplary and explanatory and are not restrictive of the present disclosure.

### BRIEF DESCRIPTION OF DRAWINGS

FIGS. 1A to 1C are views for explaining a coin processing unit according to a first embodiment.

FIG. 2 illustrates an example of a POS system according to a second embodiment.

FIG. 3 illustrates an example of hardware configuration of a cash transaction apparatus according to the second embodiment.

FIG. 4 illustrates an example of hardware configuration of a POS terminal according to the second embodiment.

FIGS. 5A and 5B illustrate an example of hardware configuration of a coin processing unit provided in a cash transaction apparatus according to the second embodiment.

FIG. 6 is a flowchart illustrating an accounting process that is performed in a POS system according to the second embodiment.

FIG. 7 is a flowchart illustrating a change dispensing process that is performed by a coin processing unit according to the second embodiment (part 1).

FIG. 8 is a flowchart illustrating the change dispensing process that is performed by the coin processing unit according to the second embodiment (part 2).

FIG. 9 illustrates examples of the number of coins to be dispensed according to the second embodiment.

FIG. 10 is a flowchart illustrating a change releasing process that is performed by a coin processing unit according to the second embodiment.

### DESCRIPTION OF EMBODIMENTS

Hereinafter, preferred embodiments will be described with reference to the accompanying drawings.

### First Embodiment

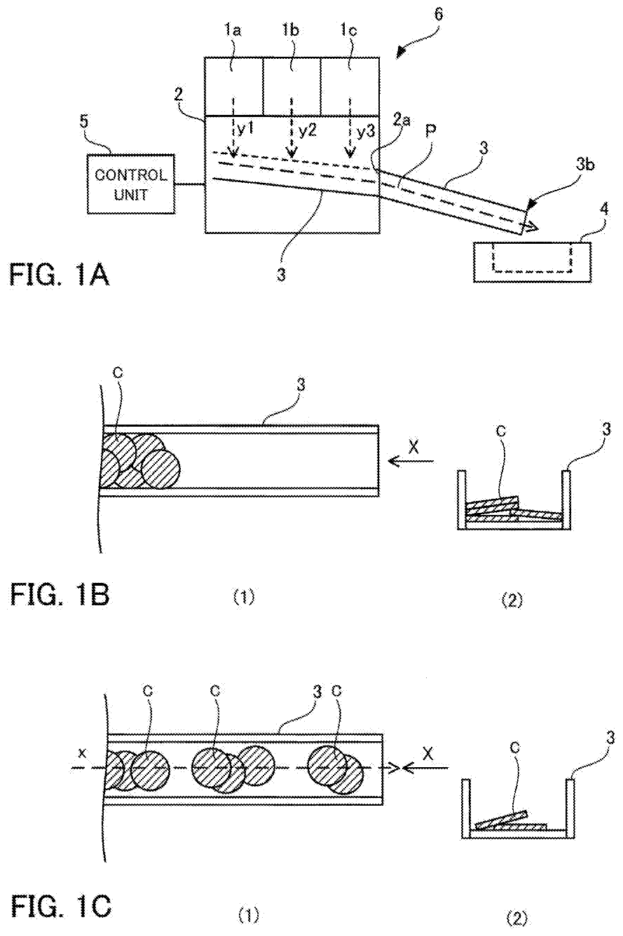

First, a coin processing unit of a first embodiment will be described with reference to FIGS. 1A to 1C.

FIGS. 1A to 1C are views for explaining a coin processing unit according to the first embodiment.

FIG. 1A illustrates the configuration of a coin processing unit 6. FIGS. 1B and 1C each illustrate a top view (1) of a coin transport unit 3 of the coin processing unit 6 and a front view (2) thereof viewed from an arrow X.

The coin processing unit 6 is able to receive and dispense coins C and is provided together with a bill processing unit, not illustrated, in a cash transaction apparatus. This coin processing unit 6 includes at least a plurality of coin storage units 1a, 1b, and 1c, a coin dispensing unit 2, the coin transport unit 3, and a control unit 5. In this connection, as illustrated in FIG. 1A, a coin receptacle 4 for receiving coins C discharged from the coin transport unit 3 is set for the coin processing unit 6.

The coin storage units 1a, 1b, and 1c store therein coins C by denomination. The number of coin storage units is not limited to three, i.e., the coin storage units 1a, 1b, and 1c, but may be determined according to the number of denominations. In the following description, the coin storage units 1a, 1b, and 1c are collectively referred to as a coin storage unit 1 unless otherwise specifically stated.

The coin dispensing unit 2 dispenses a prescribed number of coins C equivalent to a prescribed amount, released from the plurality of coin storage units 1a, 1b, and 1c, from a connection port 2a through the coin transport unit 3, to be described later. For example, the coin dispensing unit 2 is able to dispense coins C released from the coin storage units 1a, 1b, and 1c, which are illustrated in the upper part of FIG. 1A, along the arrows y1, y2, and y3.

The coin transport unit 3 has one end inserted into the coin dispensing unit 2 through the connection port 2a of the coin dispensing unit 2, and the other end, serving as an outlet port 3b, located lower than the connection port 2a of the coin dispensing unit 2, so that a prescribed number of coins C are carried from the coin dispensing unit 2 to the outlet port 3b and are discharged from the outlet port 3b to the outside. In this way, the coin transport unit 3 allows coins C released from the coin storage units 1a, 1b, and 1c to slide on the slope and exit from the outlet port 3b to the outside. In this connection, FIGS. 1A to 1C illustrate, by way of example, the case where the coin transport unit 3 has a straight structure with a U-shaped cross section. The coin transport unit 3 is not limited to the straight structure but may be curved left and right or may have a straight structure when viewed from the above and be curved upward and downward. In addition, the coin transport unit 3 may have a closed cross-section. In short, the coin transport unit 3 needs to have such a shape as to carry coins C dispensed by the coin dispensing unit 2 to the coin receptacle 4, to be described later, without fail.

The coin receptacle 4 receives a prescribed number of coins C discharged from the outlet port 3b of the coin transport unit 3. Since the coin receptacle 4 receives and holds coins C, the coin receptacle 4 needs to have a box shape, a saucer shape, or the like, for example.

The control unit 5 causes the coin dispensing unit 2 to dispense a prescribed number of coins C in a plurality of times according to the total volume of the coins C or the prescribed number of coins C. In this connection, the total volume here is calculated by multiplying the volume of a single coin C by the prescribed number of coins. In addition, the control unit 5 may determine a combination of coins C to be dispensed, on the basis of a prescribed amount to be dispensed and release coins C in the determined combination from the coin storage unit 1 to the coin dispensing unit 2. The coins C dispensed from the coin dispensing unit 2 under the control of the control unit 5 in this way are carried to the coin transport unit 3 along a path P indicated by a broken line of FIG. 1A and are discharged to the coin receptacle 4.

In this connection, the control unit 5 is implemented by executing a coin dispensing program by a CPU (central processing unit) or another processor provided in the coin processing unit 6, for example.

The following describes how the coin processing unit 6 configured as above implements a coin dispensing method according to a coin dispensing program.

First, as a comparison example, the following describes the case of simply dispensing a prescribed number of coins equivalent to a prescribed amount at a time.

In this case, when receiving a request to dispense a prescribed number of coins C equivalent to a prescribed amount, the control unit 5 determines a combination of coins C to be dispensed, on the basis of the prescribed amount. Here, for example, it is assumed that the total volume of the coins C (and the prescribed number of coins C) in the determined combination is too high (and too many) for the coins C to pass through the coin transport unit 3.

The control unit 5 then releases the coins C in the determined combination from the coin storage units 1a, 1b, and 1c to the coin dispensing unit 2 at a time, so as to dispense the coins C from the coin dispensing unit 2 to the coin transport unit 3.

As illustrated in FIG. 1B, the coins C dispensed at a time from the coin dispensing unit 2 to the coin transport unit 3 in this way get stuck in the coin transport unit 3.

By contrast, the following describes the case of dispensing a prescribed number of coins C equivalent to a prescribed amount according to the first embodiment.

As in the above case, the control unit 5 determines a combination of coins C to be dispensed, on the basis of the prescribed amount. At this time, the control unit 5 determines that the total volume of the coins C (and the prescribed number of coins C) in the determined combination is too high (and too many) for the coins C to pass through the coin transport unit 3.

The control unit 5 then releases some of the coins C in the determined combination equivalent to the prescribed amount from the coin storage units 1a, 1b, and 1c to the coin dispensing unit 2, so as to dispense the released coins C to the coin transport unit 3. The control unit 5 performs this process a plurality of times, which means causing the coin dispensing unit 2 to dispense the prescribed number of coins C in the plurality of times.

As illustrated in FIG. 1C, the coins C dispensed in this way are carried to the outlet port 3b along a broken line x in the coin transport unit 3, without getting stuck in the coin transport unit 3, and are discharged to the coin receptacle 4.

To this end, the above-described coin processing unit 6 includes the plurality of coin storage units 1 for storing therein coins by denomination and the coin dispensing unit 2 for dispensing a prescribed number of coins C equivalent to a prescribed amount, released from the plurality of coin storage units 1. The coin processing unit 6 also has the coin transport unit 3 that has one end connected to the coin dispensing unit 2 and the other end, serving as the outlet port 3b, located lower than the coin dispensing unit 2 and that carries a prescribed number of coins C dispensed by the coin dispensing unit 2 to the outlet port 3b and discharges the coins C from the outlet port 3b to the outside. The coin processing unit 6 also has the control unit 5 that causes the coin dispensing unit 2 to dispense the coins C in a plurality of times according to the total volume of the coins C or the prescribed number of coins C.

In this way, the coin processing unit 6 is able to cause the coin dispensing unit 2 to dispense coins C in a plurality of times according to the total volume of the coins C or the prescribed number of coins C. Therefore, the coins C dispensed from the coin dispensing unit 2 are carried to the outlet port 3b in the coin transport unit 3, without getting stuck in the coin transport unit 3, and then discharged to the coin receptacle 4 without fail.

### Second Embodiment

A second embodiment describes a specific example in which the coin processing unit of the first embodiment is employed.

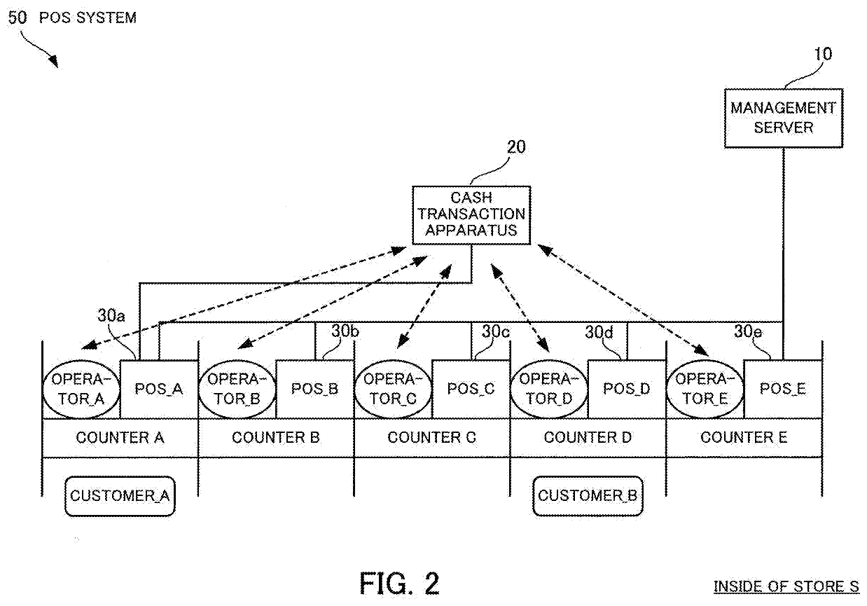

First, a POS system of the second embodiment will be described with reference to FIG. 2.

FIG. 2 illustrates an example of a POS system according to the second embodiment.

FIG. 2 is a plan view illustrating the inside of a retail store S that employs a POS system 50. This POS system 50 includes a management server 10, a cash transaction apparatus 20, and POS terminals 30a to 30e.

The management server 10 is connected to the POS terminals 30a to 30e, to be described later, over a network (as indicated by solid lines in FIG. 2) and manages the POS terminals 30a to 30e. The management server 10 receives sales information from the POS terminals 30a to 30e and sends information on unit prices, discounts, and others with respect to merchandise items to the POS terminals 30a to 30e. This management server 10 is installed in an administration room or the like inside the store S.

The cash transaction apparatus 20 includes a built-in bill processing unit for storing therein bills and receiving and dispensing bills and a built-in coin processing unit for storing therein coins and receiving and dispensing coins. The cash transaction apparatus 20 receives money from operators. In addition, the cash transaction apparatus 20 is connected to the POS terminal 30a, to be described later, and dispenses change in response to a request from the POS terminal 30a. This cash transaction apparatus 20 is connected to the POS terminal 30a over a network (as indicated by a solid line in FIG. 2) and is, for example, installed behind the POS terminals 30a to 30e inside the store S.

When operators register merchandise items into the POS terminals 30a to 30e, the POS terminals 30a to 30e each calculate the amount due for the registered merchandise items. Each POS terminal 30a to 30e then calculates, as the change, a difference between the amount due and the amount of money the customer has paid to the operator for the amount due. Here, the POS terminal 30a causes the cash transaction apparatus 20 to dispense the change, whereas the POS terminals 30b to 30e each cause the cash transaction apparatus 20 via the POS terminal 30a to dispense the change. The operator at each shop counter moves from the shop counter to the cash transaction apparatus 20 to put money the operator has received from the customer, receives change, and then returns back to the shop counter to hand the change to the customer (as illustrated by broken lines in FIG. 2).

In the following description, the POS terminals 30a to 30e are referred to as a POS terminal 30 unless otherwise specifically stated.

The following describes the hardware configuration of each component in the POS system 50.

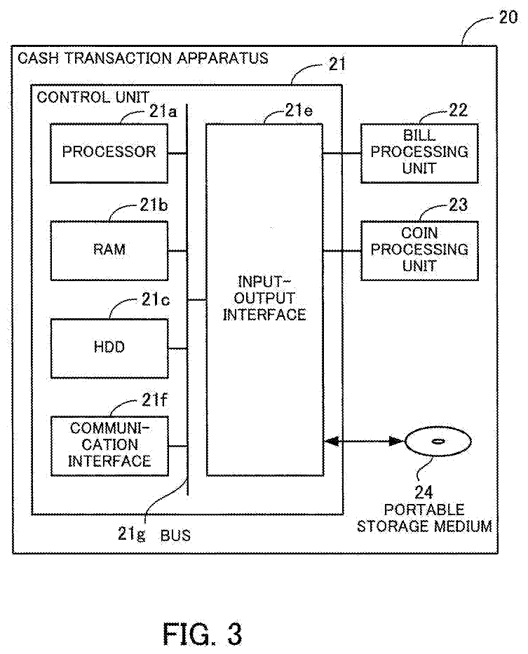

First, the hardware configuration of the cash transaction apparatus 20 will be described with reference to FIG. 3.

FIG. 3 illustrates an example of hardware configuration of a cash transaction apparatus according to the second embodiment.

The illustrated cash transaction apparatus 20 includes a control unit 21, and a bill processing unit 22 and coin processing unit 23 connected to the control unit 21.

The control unit 21 is entirely controlled by a processor 21a. The processor 21a has, connected thereto via a bus 21g, a RAM (random-access memory) 21b, an HDD (hard disk drive) 21c, an input-output interface 21e, and a communication interface 21f.

The processor 21a entirely controls the cash transaction apparatus 20. The processor 21a may be a multiprocessor. The processor 21a is, for example, a CPU, MPU (micro processing unit), DSP (digital signal processor), ASIC (application specific integrated circuit), or PLD (programmable logic device). Alternatively, the processor 21a may be a combination of two or more elements selected from a CPU, MPU, DSP, ASIC, and PLD.

The RAM 21b temporarily stores therein at least part of OS (Operating System) programs and application programs for implementing a cash transaction apparatus, which the processor 21a is to execute. The RAM 21b also stores therein various data to be used in processing by the processor 21a, data generated from the processing, and other data.

The HDD 21c stores therein OS and application programs.

The input-output interface 21e has, connected thereto, the bill processing unit 22 and the coin processing unit 23. The input-output interface 21e is connectable to a portable storage medium 24 which data is written into and read from, magnetically, using a laser beam, or another. Examples of the portable storage medium 24 include optical discs and semiconductor memories, such as flash memories. Optical discs are portable storage media on which data is recorded so as to be readable with reflection of light. Examples of the optical discs include DVDs (digital versatile discs), DVD-RAMS, CD-ROMs (compact disc-read only memories), CD-Rs (recordable), CD-RWs (rewritable), and others.

The input-output interface 21e outputs signals received from the bill processing unit 22 and coin processing unit 23 to the processor 21a via the bus 21g. Also, the input-output interface 21e outputs control signals received from the processor 21a to the bill processing unit 22 and coin processing unit 23 via the bus 21g.

The communication interface 21f is connected to the POS terminal 30a in a RS-232C (recommended standard 232 version C) or USB (universal serial bus) connection, for example. The communication interface 21f communicates data with the POS terminal 30a.

The bill processing unit 22 has a built-in bill cassette for storing bills. The bill processing unit 22 stores received bills into the bill cassette and dispenses bills from the bill cassette to the outside.

The coin processing unit 23 has a built-in coin cassette for storing coins. The coin processing unit 23 stores received coins into the coin cassette and dispenses coins from the coin cassette to the outside. In this connection, the coin processing unit 23 will be described in detail later.

The control unit 21 may be configured to include a module made up of an FPGA (field programmable gate array), DSP, and others, without the processor 21a. In this case, the control unit 21 includes a non-volatile memory (for example, EEPROM (electrically erasable and programmable read only memory), a flash memory, a flash memory card, or another) to record therein firmware for the module. The firmware may be written in the non-volatile memory via the portable storage medium 24 or the communication interface 21f. The control unit 21 is able to rewrite the firmware recorded in the non-volatile memory to update the firmware.

The management server 10 may be configured to have at least the same hardware configuration as the control unit 21 of the cash transaction apparatus 20.

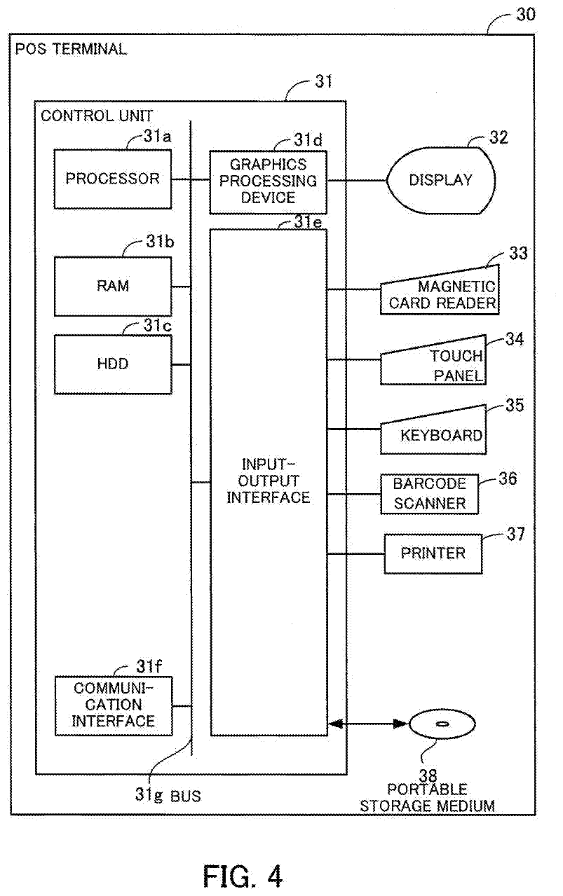

The following describes the hardware configuration of the POS terminal 30 with reference to FIG. 4.

FIG. 4 illustrates an example of hardware configuration of a POS terminal according to the second embodiment.

The illustrated POS terminal 30 includes a control unit 31, to which a variety of input-output devices are connected.

The control unit 31 is entirely controlled by a processor 31a. The processor 31a has, connected thereto via a bus 31g, a RAM 31b, an HDD 31c, a graphics processing device 31d, an input-output interface 31e, and a communication interface 31f.

The processor 31a entirely controls the POS terminal 30. The processor 31a may be a multiprocessor. The processor 31a is, for example, a CPU, MPU, DSP, ASIC, or PLD. Alternatively, the processor 31a may be a combination of two or more elements selected from a CPU, MPU, DSP, ASIC, and PLD.

The RAM 31b temporarily stores therein at least part of OS programs and application programs for implementing the POS terminal 30, which the processor 31a is to execute. In addition, the RAM 31b stores therein various data to be used in processing by the processor 31a, data generated from the processing, and other data.

The HDD 31c stores therein OS and application programs.

The graphics processing device 31d has a display 32 connected thereto. The graphics processing device 31d displays images on the screen of the display 32 in accordance with commands from the processor 31a.

The input-output interface 31e has, connected thereto, a magnetic card reader 33, a touch panel 34, a keyboard 35, a barcode scanner 36, and a printer 37. The input-output interface 31e is connectable to a portable storage medium 38 which data is written into and read from, magnetically, using a laser beam, or another. Examples of the portable storage medium 38 include optical discs and semiconductor memories, such as flash memories. Optical discs are portable storage media on which data is recorded so as to be readable with reflection of light. Examples of the optical discs include DVDs, DVD-RAMS, CD-ROMs, CD-Rs, CD-RWs, and others.

The input-output interface 31e outputs signals received from the magnetic card reader 33, touch panel 34, keyboard 35, barcode scanner 36, printer 37, and portable storage medium 38 to the processor 31a via the bus 31g.

The communication interface 31f is connected to the management server 10 in a RS-232C or USB connection, for example. In this connection, the POS terminal 30a is connected to the cash transaction apparatus 20 and POS terminals 30b to 30e. The communication interface 31f communicates data with each connected device. In addition, the communication interface 31f uses WS (web services)-POS, which is next-generation POS standardization that enables controlling POS neighboring devices over a network. The WS-POS enables controlling apparatuses connected over a network. Therefore, for example, in response to requests from the POS terminals 30b to 30e, the POS terminal 30a is able to control the cash transaction apparatus 20, which is not connected directly to the POS terminals 30b to 30e over a network.

With the above hardware configuration, the processing functions of the second embodiment are implemented.

The control unit 31 may be configured to include a module made up of an FPGA, a DSP, and others, without the processor 31a. In this case, the control unit 31 includes a non-volatile memory (for example, an EEPROM, a flash memory, a flash memory card, or another) to record therein firmware for the module. The firmware may be written in the non-volatile memory via the portable storage medium 38 or the communication interface 31f. The control unit 31 is able to rewrite the firmware recorded in the non-volatile memory to update the firmware.

With respect to the POS terminal 30, the POS terminals 30b to 30e are connected to the management server 10 and POS terminal 30a via their communication interfaces 31f.

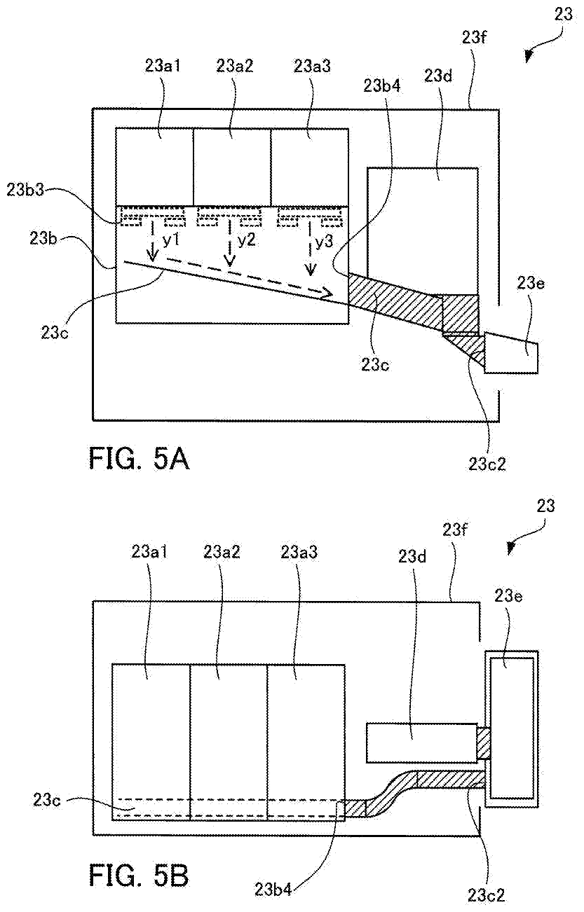

The following describes the coin processing unit 23 provided in the cash transaction apparatus 20 with reference to FIGS. 5A and 5B.

FIGS. 5A and 5B illustrate an example of hardware configuration of a coin processing unit provided in a cash transaction apparatus according to the second embodiment.

FIG. 5A is a transparent side view of the coin processing unit 23, whereas FIG. 5B is a transparent top view of the coin processing unit 23.

The coin processing unit 23 has, for example, three different coin cassettes 23a1, 23a2, and 23a3, a coin dispensing unit 23b, a coin transport unit 23c, and a coin accepting unit 23d inside a case 23f thereof. In addition, the coin processing unit 23 has a coin case 23e at a location where coins are discharged from the coin transport unit 23c.

The coin cassettes 23a1, 23a2, and 23a3 store therein coins by denomination, and are disposed over the coin dispensing unit 23b.

The coin transport unit 23c, to be described later, is inserted in the coin dispensing unit 23b, so that coins released from the coin cassettes 23a1, 23a2, and 23a3 are carried by the coin transport unit 23c. In addition, the coin dispensing unit 23b is provided with releasing sensors 23b3 at locations where coins are released from the coin cassettes 23a1, 23a2, and 23a3, and is controlled by the control unit 21 of the cash transaction apparatus 20. For example, on the basis of a control signal from the control unit 21, a total of four coins, i.e., one coin, two coins, and one coin, are released from the coin cassettes 23a1, 23a2, and 23a3, respectively, and the releasing sensors 23b3 detect the releasing. The four released coins are discharged to the coin case 23e through the coin transport unit 23c.

One end of the coin transport unit 23c is inserted into the coin dispensing unit 23b through a connection port 23b4 of the coin dispensing unit 23b, and the other end thereof, serving as an outlet port 23c2, is located lower than the connection port 23b4 of the coin dispensing unit 23b. The coin transport unit 23c dispenses coins released from the coin cassettes 23a1, 23a2, and 23a3 from the connection port 23b4 of the coin dispensing unit 23b, carries them to the outlet port 23c2, and discharges them to the external coin case 23e.

FIGS. 5A and 5B illustrate an example in which the coin transport unit 23c is curved in a portion between the connection port 23b4 of the coin dispensing unit 23b and the coin case 23e. Alternatively, the coin transport unit 23c may have another shape as long as the coin transport unit 23c is able to carry coins dispensed by the connection port 23b4 of the coin dispensing unit 23b to the coin case 23e without fail. In addition, the coin transport unit 23c may have a U-shaped or a closed cross-section.

In addition, the control unit 21 manages the number of coins stored in each coin cassette 23a1, 23a2, and 23a3. The control unit 21 updates the managed number of coins according to the number of coins released from each coin cassette 23a1, 23a2, and 23a3.

The coin accepting unit 23d receives coins and counts the number of received coins. If the coin accepting unit 23d is not able to verify the authenticity of received coins, the coin accepting unit 23d discharges the coins to the coin case 23e.

The coin case 23e receives coins discharged from the outlet port 23c2 of the coin transport unit 23c and the coin accepting unit 23d. Since the coin case 23e receives and holds coins, the coin case 23e needs to have a box shape, a saucer shape, or another shape, for example.

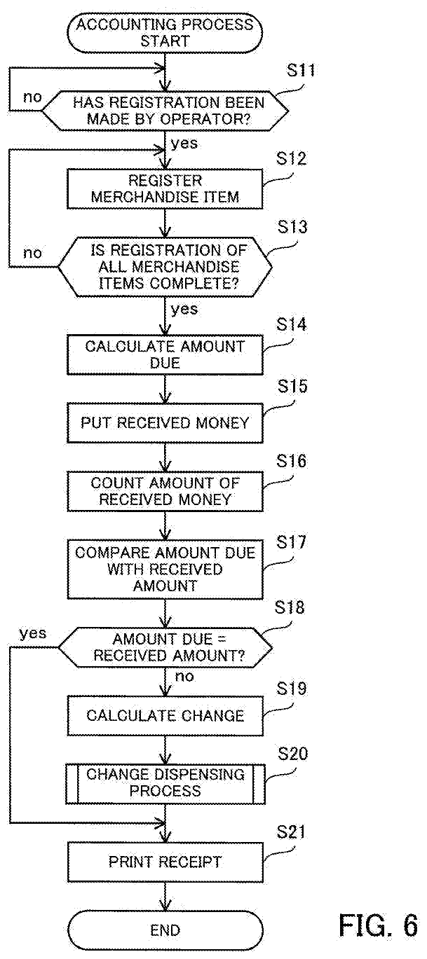

The following describes an accounting process that is performed in the POS system 50 configured as above, with reference to FIG. 6.

FIG. 6 is a flowchart illustrating an accounting process that is performed in a POS system according to the second embodiment.

(Step S11) The control unit 31 of the POS terminal 30 waits for registration by an operator in charge of accounting operation, and when receiving registration from the operator, the process proceeds to step S12.

(Step S12) When the operator reads the barcode on a merchandise item the operator has received from the customer with the barcode scanner 36, the control unit 31 of the POS terminal 30 registers the merchandise item on the basis of the read barcode.

(Step S13) When the control unit 31 of the POS terminal 30 has received a completion notification as to the registration of all merchandise items from the operator, the process proceeds to step S14.

In this connection, steps S12 and S13 are repeated until the registration of all merchandise items is completed.

(Step S14) The control unit 31 of the POS terminal 30 calculates the amount due for the merchandise items registered at steps S12 and S13.

(Step S15) The operator receives money for the amount due from the customer and takes it to the cash transaction apparatus 20. The operator then puts the received money into the cash transaction apparatus 20.

(Step S16) The control unit 21 of the cash transaction apparatus 20 counts the amount of the money received at step S15. The cash transaction apparatus 20 sends a notification of the received amount to the POS terminal 30.

(Step S17) The control unit 31 of the POS terminal 30 compares the amount due of step S14 with the received amount counted at step S16.

(Step S18) The control unit 31 of the POS terminal 30 determines whether the amount due matches the received amount.

If the amount due does not match the received amount, the process proceeds to step S19. If the amount due matches the received amount, the process proceeds to step S21.

(Step S19) The control unit 31 of the POS terminal 30 calculates the change by subtracting the amount due from the received amount.

(Step S20) The control unit 31 of the POS terminal 30 sends a request to dispense the change calculated at step S19 to the cash transaction apparatus 20. The cash transaction apparatus 20 performs a dispensing process for the requested change.

The operator takes the dispensed change to the original POS terminal 30.

In this connection, this change dispensing process will be described in detail later.

(Step S21) The POS terminal 30 causes the printer 37 to print a receipt on which the merchandise items, the received amount, the amount due (change as needed), and others are written. The operator hands the receipt (and change if any) together with the merchandise items to the customer.

The accounting process in the POS system 50 is now complete.

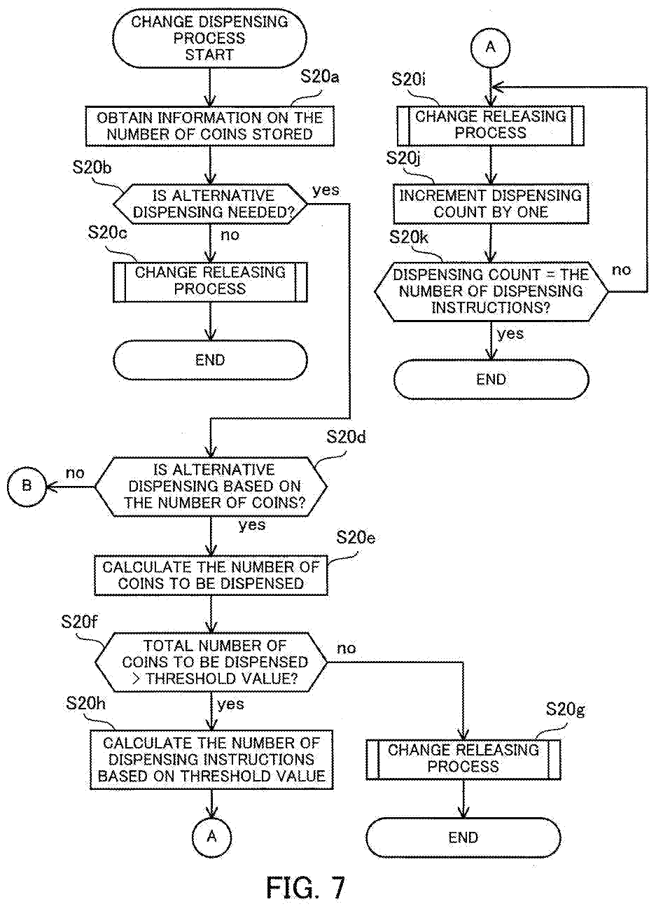

The following describes the change dispensing process of step S20 in the above flowchart of the accounting process, with reference to FIGS. 7 to 9.

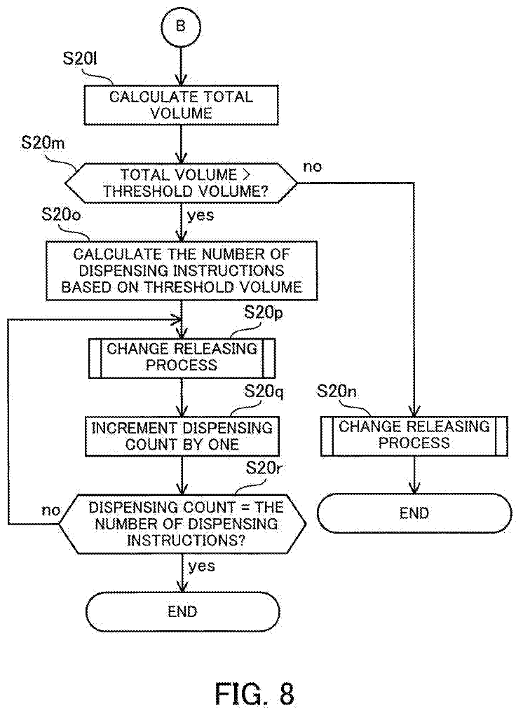

FIGS. 7 and 8 are a flowchart illustrating a change dispensing process that is performed by a coin processing unit according to the second embodiment.

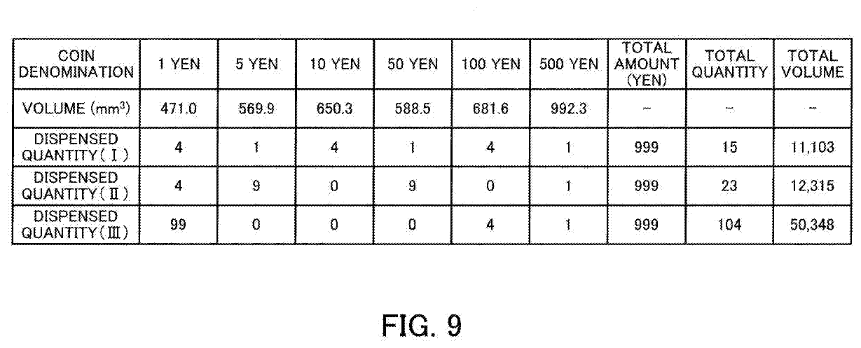

FIG. 9 illustrates examples of the number of coins to be dispensed according to the second embodiment. In this connection, FIG. 9 illustrates three different combinations of coins that make up 999 yen change.

The control unit 21 of the cash transaction apparatus 20 performs the following process when receiving a request to dispense change from the control unit 31 of the POS terminal 30. In this connection, it is assumed that the cash transaction apparatus 20 is able to perform alternative dispensing depending on the number of coins or the total volume of the coins.

In this connection, the alternative dispensing means that coins of denominations different from those originally determined are dispensed. For example, two 100-yen coins are usually dispensed in the case of 200 yen change. However, one 100-yen coin and two 50-yen coins are dispensed due to a shortage of 100-yen coins. In this way, the alternative dispensing tends to increase the number of coins dispensed (and the total volume of the coins).

(Step S20a) The control unit 21 of the cash transaction apparatus 20 obtains information on the number of coins stored in each coin cassette 23a1, 23a2, and 23a3 of the coin processing unit 23.

As described earlier, the control unit 21 of the cash transaction apparatus 20 manages the number of coins stored in each coin cassette 23a1, 23a2, and 23a3. The control unit 21 obtains information on these numbers of coins.

(Step S20b) The control unit 21 of the cash transaction apparatus 20 determines whether alternative dispensing needs to be performed for the change requested for dispensing by the POS terminal 30, on the basis of the number of coins stored in each coin cassette 23a1, 23a2, and 23a3, informed of at step S20a. If the control unit 21 determines that the alternative dispensing is not needed, the process proceeds to step S20c. If the control unit 21 determines that the alternative dispensing is needed, the process proceeds to step S20d.

In this connection, the control unit 21 calculates, for each denomination, the minimum number of coins to make up the change requested for dispensing by the POS terminal 30. If the number of coins stored in a coin cassette 23a1, 23a2, or 23a3 is not sufficient to dispense the corresponding minimum number of coins to make up the change, the control unit 21 determines that the alternative dispensing is needed.

(Step S20c) The control unit 21 of the cash transaction apparatus 20 causes the coin processing unit 23 to release the change.

In this connection, step S20c will be described in detail later.

The change dispensing process by the coin processing unit 23 is now complete.

(Step S20d) The control unit 21 of the cash transaction apparatus 20 determines whether the alternative dispensing is based on the number of coins. If the alternative dispensing is based on the number of coins, the process proceeds to step S20e. If the alternative dispensing is not based on the number of coins, the process proceeds to step S201 (FIG. 8).

(Step S20e) The control unit 21 of the cash transaction apparatus 20 calculates the total number of coins to be dispensed for the change in the alternative dispensing.

On the basis of the number of coins stored in each coin cassette 23a1, 23a2, and 23a3, the control unit 21 detects a denomination of coins that are fewer than the minimum number of coins calculated to make up the change at step S20b. The control unit 21 replaces the coins of the detected denomination with coins of one or more different denominations on the basis of the number of coins stored in each coin cassette 23a1, 23a2, and 23a3. The control unit 21 calculates, with respect to the change for which the minimum number of coins is determined at step S20b, the total number of coins to be dispensed in the alternative dispensing, including the number of coins after the replacement.

(Step S20f) The control unit 21 of the cash transaction apparatus 20 determines whether the total number of coins to be dispensed for the change in the alternative dispensing is greater than a prescribed threshold value. If the total number of coins to be dispensed for the change in the alternative dispensing is less than or equal to the prescribed threshold value, the process proceeds to step S20g. If the total number of coins to be dispensed for the change in the alternative dispensing is greater than the prescribed threshold value, the process proceeds to step S20h.

If the total number of coins to be dispensed is less than or equal to the prescribed threshold value, it means that the occurrence of a coin jam in the coin transport unit 23c is prevented when the coins are dispensed. To this end, the prescribed threshold value is appropriately set according to the size (sectional area) of the coin transport unit 23c through which coins pass.

The following describes an example in which change is 999 yen and the prescribed threshold value is 20, with reference to FIG. 9.

In this connection, FIG. 9 illustrates the volume (mm³) of a coin of each denomination (1 yen, 5 yen, 10 yen, 50 yen, 100 yen, and 500 yen), and the total amount (yen), the total quantity of coins, and the total volume of coins with respect to three different dispensed quantities.

In the case of the dispensed quantity (I) in FIG. 9, the total quantity is 15, less than the prescribed threshold value (20). Therefore, the process proceeds to step S20g.

In the case of the dispensed quantities (II) and (III) in FIG. 9, the total quantities are 23 and 104, respectively, greater than the prescribed threshold value (20). Therefore, the process proceeds to step S20h.

(Step S20g) The control unit 21 of the cash transaction apparatus 20 causes the coin processing unit 23 to dispense the change with the alternative dispensing.

In this connection, step S20g will be described in detail later.

For example, in the case of the dispensed quantity (I) in FIG. 9, a total of 15 coins (999 yen) are dispensed as the change.

The change dispensing process by the coin processing unit 23 is now complete.

(Step S20h) The control unit 21 of the cash transaction apparatus 20 calculates the number of dispensing instructions indicating how many times coins based on the prescribed threshold value are to be dispensed in the alternative dispensing for the change.

For example, in the case of the dispensed quantity (II) in FIG. 9, the number of dispensing instructions is calculated to be 2 (1.15=23 coins/20 coins).

In the case of the dispensed quantity (III) in FIG. 9, the number of dispensing instructions is calculated to be 6 (5.2=104 coins/20 coins).

(Step S20i) The control unit 21 of the cash transaction apparatus 20 causes the coin processing unit 23 to dispense the change with the threshold value (for example, 20 coins) as a basis.

In this connection, step S20i will be described in detail later.

(Step S20j) The control unit 21 of the cash transaction apparatus 20 increments a dispensing count by one.

(Step S20k) The control unit 21 of the cash transaction apparatus 20 determines whether the dispensing count matches the number of dispensing instructions. If the dispensing count does not match the number of dispensing instructions, the process proceeds back to step S20i. If the dispensing count matches the number of dispensing instructions, the change dispensing process by the coin processing unit 23 is completed.

For example, in the case of the dispensed quantity (II) in FIG. 9, the change dispensing process by the coin processing unit 23 is completed when the dispensing count reaches two that is the number of dispensing instructions.

In the case of the dispensed quantity (III) in FIG. 9, the change dispensing process by the coin processing unit 23 is completed when the dispensing count reaches six that is the number of dispensing instructions.

(Step S20l) The control unit 21 of the cash transaction apparatus 20 calculates the total volume of the coins for the change in the alternative dispensing.

(Step S20m) The control unit 21 of the cash transaction apparatus 20 determines whether the total volume of the coins for the change in the alternative dispensing is greater than a prescribed threshold volume. If the total volume of the coins for the change in the alternative dispensing is less than or equal to the prescribed threshold volume, the process proceeds to step S20n. If the total volume of the coins for the change in the alternative dispensing is greater than the prescribed threshold volume, the process proceeds to step S20o.

In this connection, the threshold voltage is set to preclude the occurrence of a coin jam in the coin transport unit 23c when coins are dispensed. Therefore, the threshold voltage is appropriately set according to the size (sectional area) of the coin transport unit 23c through which coins pass.

The following describes an example in which change is 999 yen and the threshold volume is set to 12,000 mm³, with reference to FIG. 9.

In the case of the dispensed quantity (I) in FIG. 9, the total volume of the coins is 11.103 mm³, less than the threshold volume (12,000 mm³). Therefore, the process proceeds to step S20n.

In the cases of the dispensed quantities (II) and (III) in FIG. 9, the total volumes of the coins are 12,315 mm³ and 50,348 mm³, respectively, both greater than the threshold volume (12,000 mm³). Therefore, the process proceeds to step S20o.

(Step S20n) The control unit 21 of the cash transaction apparatus 20 causes the coin processing unit 23 to dispense the change with the alternative dispensing.

Step S20n will be described in detail later.

For example, in the case of the dispensed quantity (I) in FIG. 9, the coins (999 yen) with the total volume of 11,103 mm³ are dispensed as the change.

The change dispensing process by the coin processing unit 23 is now complete.

(Step S20o) The control unit 21 of the cash transaction apparatus 20 calculates the number of dispensing instructions for dispensing coins based on the threshold volume in the alternative dispensing for the change.

For example, in the case of the dispensed quantity (II) in FIG. 9, the number of dispensing instructions is calculated to be two (1.03≈12,315 mm³/12,000 mm³).

For example, in the case of the dispensed quantity (III) in FIG. 9, the number of dispensing instructions is calculated to be five (4.20≈50,348 mm³/12,000 mm³).

(Step S20p) The control unit 21 of the cash transaction apparatus 20 causes the coin processing unit 23 to dispense part of the change equivalent to the prescribed volume (for example, 12,000 mm³).

Step S20p will be described in detail later.

(Step S20q) The control unit 21 of the cash transaction apparatus 20 increments the dispensing count by one.

(Step S20r) The control unit 21 of the cash transaction apparatus 20 determines whether the dispensing count matches the number of dispensing instructions. If the dispensing count does not match the number of dispensing instructions, the process proceeds back to step S20p. If the dispensing count matches the number of dispensing instructions, the change dispensing process by the coin processing unit 23 is completed.

For example, in the case of the dispensed quantity (II) in FIG. 9, the change dispensing process by the coin processing unit 23 is completed when the dispensing count reaches two that is the number of dispensing instructions.

In the case of the dispensed quantity (III) in FIG. 9, the change dispensing process by the coin processing unit 23 is completed when the dispensing count reaches five that is the number of dispensing instructions.

In summary, the above-described coin processing unit 23 of the cash transaction apparatus 20 includes the coin cassettes 23a1, 23a2, and 23a3 for storing therein coins by denomination and the coin dispensing unit 23b for dispensing a prescribed number of coins equivalent to a prescribed amount, released from the coin cassettes 23a1, 23a2, and 23a3. The coin processing unit 23 also includes the coin transport unit 23c that has one end connected to the coin dispensing unit 23b and the other end, serving as the outlet port 23c2, located lower than the coin dispensing unit 23b and that carries a prescribed number of coins dispensed by the coin dispensing unit 23b to the outlet port 23c2 and discharges the coins from the outlet port 23c2 to the outside. In this connection, the coin processing unit 23 causes the coin dispensing unit 23b to dispense a prescribed number of coins in a plurality of times according to the prescribed number of coins or the total volume of the coins under the control of the control unit 21.

As a result, the coin processing unit 23 is able to cause the coin dispensing unit 23b to dispense coins in a plurality of times according to the number of coins or the total volume of the coins. Therefore, the coins dispensed from the coin dispensing unit 23b to the coin transport unit 23c are carried to the outlet port 23c2 through the coin transport unit 23c, without getting stuck in the coin transport unit 23c, and then are discharged to the coin case 23e.

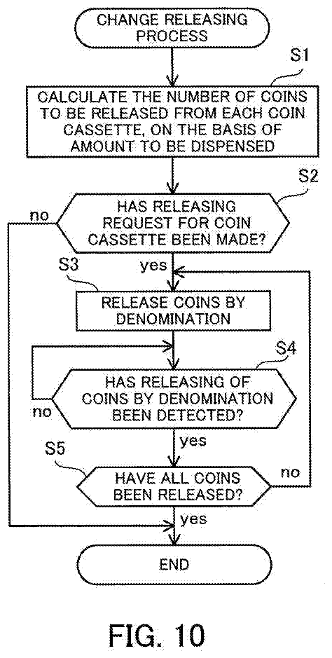

The following describes in detail the change releasing process that is performed by the coin processing unit 23 to release coins from the coin cassettes A, B, and C at steps S20c, S20i, S20g, S20n and S20p in the above flowchart of the change dispensing process, with reference to FIG. 10.

FIG. 10 is a flowchart illustrating a change releasing process that is performed by a coin processing unit according to the second embodiment.

In the following description, the coin cassettes 23a1, 23a2, and 23a3 are referred to as coin cassettes A, B, and C, respectively.

(Step S1) When receiving a request to dispense coins for change from the POS terminal 30, the control unit 21 of the cash transaction apparatus 20 calculates, for each denomination of coins to be released from the coin cassettes A, B, and C, the number of coins (or a threshold value) to be specified to the coin processing unit 23 for the following process.

(Step S2) The control unit 21 determines, based on the specified number of coins calculated for each denomination at step S1, whether coin releasing has been requested for the coin cassettes A, B, and C.

If the coin releasing has been requested for at least one of the coin cassettes A, B, and C, the process proceeds to step S3. If no coin releasing has been requested for the coin cassettes A, B, and C, the coin releasing process is completed.

(Step S3) The control unit 21 drives one or more coin cassettes A, B, and C of the coin processing unit 23 corresponding to the denominations of coins requested to be released at step S2 and causes each driven coin cassette A, B, and C to release the specified number of coins.

(Step S4) When the releasing sensors 23b3 respectively corresponding to the coin cassettes A, B, and C of the coin processing unit 23 detect the releasing of coins from the coin cassettes A, B, and C, the control unit 21 advances the process to step S5.

(Step S5) The control unit 21 determines whether the specified number of coins have been released from each driven coin cassette A, B, and C.

If the specified number of coins have been released from each coin cassette A, B, and C, the coin releasing process is completed. If the specified number of coins have not been released from each coin cassette A, B, and C, the process proceeds back to step S3.

The second embodiment has described the case of dispensing change from the coin processing unit 23 of the cash transaction apparatus 20, by way of example. The disclosed approach is not limited to this configuration but may be applied to the case of collecting coins stored in the coin cassettes 23a1, 23a2, and 23a3 of the coin processing unit 23 of the cash transaction apparatus 20.

The processing functions described above may be implemented by a computer. In this case, programs describing the processing contents of the functions to be implemented by a computer are distributed. The processing functions described above are implemented on a computer while the computer executes the programs.

Programs describing the processing content may be stored in computer-readable storage media. The computer-readable storage media include magnetic storage devices, optical discs, magneto-optical storage media, semiconductor memories, and others. The magnetic storage devices include HDDs, flexible disks (FDs), magnetic tapes (MTs), and others. The optical discs include DVDs, DVD-RAMS, CD-ROMs, CD-Rs, CD-RWs, and others. The magneto-optical storage media include MOs (magneto-optical disks) and others. The semiconductor memories include flash memories such as USB memories.

To distribute the programs, portable storage media, such as DVDs and CD-ROMs, storing the programs are put on sale, for example. Alternatively, the programs may be stored in a server computer and are then forwarded from the server computer to other computers over a network.

A computer that executes the programs stores the programs recorded in a portable storage medium or forwarded from the server computer into its local storage device. Then, the computer reads the programs from its own storage device and executes processes according to the programs. The computer may read the programs directly from the portable storage medium to execute processes according to the programs. Further, while receiving the programs forwarded from the server computer, the computer may execute processes according to the programs.

Some or all of the processes described in the programs may be replaced by electronic circuits. At least some of the processing functions described above may be implemented by electronic circuits, such as a DSP, ASIC, and PLD.

According to the disclosed technique, the occurrence of a coin jam is precluded.

All examples and conditional language provided herein are intended for the pedagogical purposes of aiding the reader in understanding the present disclosure and the concepts contributed by the inventor to further the art, and are not to be construed as limitations to such specifically recited examples and conditions, nor does the organization of such examples in the specification relate to a showing of the superiority and inferiority of the present disclosure. Although one or more embodiments of the present disclosure have been described in detail, it should be understood that various changes, substitutions, and alterations could be made hereto without departing from the spirit and scope of the present disclosure.

What is claimed is:

1. A coin dispensing method, comprising:
causing, by a processor, a coin dispensing unit to dispense, to a coin transport unit, a prescribed number of coins equivalent to a prescribed amount, released from a coin storage unit, in a plurality of times according to the prescribed number of coins, the coin storage unit storing therein coins by denomination; and
carrying, by the coin transport unit, the prescribed number of coins dispensed by the coin dispensing unit to an outlet port of the coin transport unit and discharging the prescribed number of coins from the outlet port to outside, the coin transport unit having one end connected to the coin dispensing unit and another end, serving as the outlet port, located lower than the coin dispensing unit.

2. The coin dispensing method according to claim 1, wherein the causing includes causing the coin dispensing unit to dispense the prescribed number of coins in the plurality of times according to a total volume of the prescribed number of coins, in place of the prescribed number of coins.

3. A cash transaction apparatus including a coin processing unit comprising:
a coin storage unit configured to store therein coins by denomination;
a coin dispensing unit configured to dispense a prescribed number of coins equivalent to a prescribed amount, released from the coin storage unit;
a coin transport unit having one end connected to the coin dispensing unit and another end, serving as an outlet port, located lower than the coin dispensing unit, the coin transport unit being configured to carry the prescribed number of coins dispensed by the coin dispensing unit to the outlet port and discharge the prescribed number of coins from the outlet port to outside; and
a processor configured to cause the coin dispensing unit to dispense the prescribed number of coins in a plurality of times according to the prescribed number of coins.

4. The cash transaction apparatus according to claim 3, wherein the processor causes the coin dispensing unit to dispense the prescribed number of coins in the plurality of times according to a total volume of the prescribed number of coins, in place of the prescribed number of coins.

5. A non-transitory computer-readable storage medium storing a coin dispensing program that causes a computer to perform a process comprising:
causing a coin dispensing unit to dispense, to a coin transport unit, a prescribed number of coins equivalent to a prescribed amount, released from a coin storage unit, in a plurality of times according to the prescribed number of coins, wherein
the coin storage unit stores therein coins by denomination, and
the coin transport unit has one end connected to the coin dispensing unit and another end, serving as an outlet port, located lower than the coin dispensing unit and is configured to carry the prescribed number of coins dispensed by the coin dispensing unit to the outlet port and discharge the prescribed number of coins from the outlet port to outside.

6. The non-transitory computer-readable storage medium according to claim 5, wherein the causing includes causing the coin dispensing unit to dispense the prescribed number of coins in the plurality of times in response to the prescribed number of coins being greater than a threshold value.

7. The non-transitory computer-readable storage medium according to claim 6, wherein the plurality of times is a prescribed number of times calculated based on a quotient calculated by dividing the prescribed number of coins by the threshold value.

8. The non-transitory computer-readable storage medium according to claim 5, wherein the causing includes causing the coin dispensing unit to dispense the prescribed number of coins in the plurality of times according to a total volume of the prescribed number of coins, in place of the prescribed number of coins.
